(19) United States
(12) Patent Application Publication
(10) Pub. No.: US 2025/0356381 A1
(43) Pub. Date: Nov. 20, 2025

(54) INFORMATION PROCESSING APPARATUS, INFORMATION PROCESSING METHOD, AND PROGRAM

(71) Applicant: FUJIFILM Corporation, Tokyo (JP)

(72) Inventor: Masahiro SATO, Tokyo (JP)

(73) Assignee: FUJIFILM Corporation, Tokyo (JP)

(21) Appl. No.: 19/204,615

(22) Filed: May 12, 2025

(30) Foreign Application Priority Data
May 16, 2024 (JP) 2024-080313

(51) Int. Cl. G06Q 30/0202; G06N 20/00; G06Q 30/0201

(52) U.S. Cl. CPC G06Q 30/0202; G06N 20/00; G06Q 30/0206

(57) ABSTRACT

There are provided an information processing apparatus, an information processing method, and a program that reduce a bias by accurately correcting a prediction value of an item having a high rank prediction value. A processor is configured to: acquire verification data for verifying a relationship between a prediction value output from a predictor that predicts an evaluation of a user for a candidate item and a true value of the evaluation of the user for the candidate item; input the verification data to the predictor, and acquire a high rank item which is a candidate item of which a rank of the output prediction value is relatively high; extract high rank data corresponding to the high rank item from the verification data; and train a corrector that corrects an input prediction value such that the input prediction value is close to the true value based on the high rank data.

### CROSS-REFERENCE TO RELATED APPLICATION

The present application claims priority under 35 U.S.C § 119 (a) to Japanese Patent Application No. 2024-080313 filed on May 16, 2024, which is hereby expressly incorporated by reference, in its entirety, into the present application.

### BACKGROUND OF THE INVENTION

### 1. Field of the Invention

The present disclosure relates to an information processing apparatus, an information processing method, and a program, and particularly to a technology of reducing a bias of a prediction value.

### 2. Description of the Related Art

There is known a recommendation system that predicts an evaluation value of an item according to a user and a context, and recommends an item having a high prediction evaluation value (prediction value) which is the predicted evaluation value to the user.

JP2020-154488A discloses an information processing apparatus comprising a prediction indicator derivation unit that derives a prediction indicator obtained by predicting an indicator related to a content for each of a plurality of contents which are candidates of the content to be provided to a terminal device, a ranking processing unit that ranks the plurality of contents based on a rank indicator based on the prediction indicator derived by the prediction indicator derivation unit, and a prediction indicator correction unit that corrects the prediction indicator to reduce a bias associated with the rank.

### SUMMARY OF THE INVENTION

There is a prediction error in the prediction of the evaluation value, and there is an item that is predicted to be higher than a true value (overestimation) and an item that is predicted to be lower than the true value (underestimation).

There are many overestimated items for items with high rank prediction values. Since a recommendation item is an item having a high rank prediction value, a bias that is likely to be overestimated occurs. As a result, problems occur, such as (1) a case where a user is disappointed due to excessive expectations in a case where a predicted evaluation value is presented to the user and (2) a case where a stock is not sold as expected in a case where the stock is purchased based on a predicted purchase rate and, resulting in excess stock.

The present invention has been made in view of such circumstances, and an object of the present invention is to provide an information processing apparatus, an information processing method, and a program that reduce a bias by accurately correcting a prediction value of an item having a high rank prediction value.

In order to achieve the above object, according to a first aspect of the present disclosure, there is provided an information processing apparatus comprising: one or more processors; and one or more memories that store a command to be executed by the one or more processors, in which the processor is configured to: acquire verification data for verifying a relationship between a prediction value output from a predictor that predicts an evaluation of a user for a candidate item and a true value of the evaluation of the user for the candidate item; input the verification data to the predictor, and acquire a high rank item which is a candidate item of which a rank of the output prediction value is relatively high; extract high rank data corresponding to the high rank item from the verification data; and train a corrector that corrects an input prediction value such that the input prediction value is close to the true value based on the high rank data.

With the present aspect, since the corrector that corrects the prediction value based on the high rank data is trained, it is possible to reduce a bias by correcting the prediction value of the item with a high prediction value with high accuracy.

According to an information processing apparatus according to a second aspect of the present disclosure, in the information processing apparatus according to the first aspect, it is preferable that the processor is configured to: predict each evaluation of the user for each candidate item of a plurality of candidate items by using the predictor; select a candidate item of which a rank of a prediction value is relatively higher among the plurality of candidate items, as a recommendation item to be recommended to the user; correct the prediction value of the recommendation item by using the corrector; and output the recommendation item and the corrected prediction value.

According to an information processing apparatus according to a third aspect of the present disclosure, in the information processing apparatus according to the first aspect or the second aspect, it is preferable that the predictor predicts the evaluation of the user by using collaborative filtering.

According to an information processing apparatus according to a fourth aspect of the present disclosure, in the information processing apparatus according to any one of the first to third aspects, it is preferable that the predictor includes a trained model, and the processor is configured to: divide a plurality of pieces of data to use a part of the data for training of the predictor and to use a remaining part of the data as the verification data.

According to an information processing apparatus according to a fifth aspect of the present disclosure, in the information processing apparatus according to any one of the first to fourth aspects, it is preferable that the processor is configured to: limit the high rank item to a candidate item for which the evaluation of the user exists in the verification data.

According to an information processing apparatus according to a sixth aspect of the present disclosure, in the information processing apparatus according to any one of the second to fifth aspects, it is preferable that the processor is configured to: extract the number of high rank items equal to the number of recommendation items.

According to an information processing apparatus according to a seventh aspect of the present disclosure, in the information processing apparatus according to any one of the first to sixth aspects, it is preferable that the corrector includes a parametric model or a nonparametric model in which the prediction value is an explanatory variable and the true value is a response variable.

According to an information processing apparatus according to an eighth aspect of the present disclosure, in the information processing apparatus according to any one of the first to seventh aspects, it is preferable the corrector corrects the prediction value according to the rank of the prediction value of the high rank item.

According to an information processing apparatus according to a ninth aspect of the present disclosure, in the information processing apparatus according to the seventh aspect, it is preferable that the corrector includes the rank of the prediction value in the explanatory variable.

According to an information processing apparatus according to a tenth aspect of the present disclosure, in the information processing apparatus according to any one of the first to ninth aspects, it is preferable that the processor is configured to: correct the prediction value by assigning a relatively higher weight to a prediction value having a relatively higher rank.

According to an information processing apparatus according to an eleventh aspect of the present disclosure, in the information processing apparatus according to the tenth aspect, it is preferable that the corrector is trained by assigning the relatively higher weight to the prediction value having a relatively higher rank.

In order to achieve the above object, according to a twelfth aspect of the present disclosure, there is provided an information processing method executed by one or more processors, in which the one or more processors are configured to: acquire verification data for verifying a relationship between a prediction value output from a predictor that predicts an evaluation of a user for a candidate item and a true value of the evaluation of the user for the candidate item; input the verification data to the predictor, and acquire a high rank item which is a candidate item of which a rank of the output prediction value is relatively high; extract high rank data corresponding to the high rank item from the verification data; and train a corrector that corrects an input prediction value such that the input prediction value is close to the true value based on the high rank data.

The information processing method according to the twelfth aspect may include the same specific aspects as the information processing apparatus described above.

In order to achieve the above object, according to a thirteenth aspect of the present disclosure, there is provided a program causing a computer to realize the information processing method according to the twelfth aspect. The present disclosure also includes a non-transitory computer-readable storage medium in which the program according to the thirteenth aspect is stored.

The program according to the thirteenth aspect and the storage medium storing the program according to the thirteenth aspect may have the same specific aspects as the information processing apparatus described above.

According to the present disclosure, it is possible to reduce a bias by accurately correcting a prediction value of an item with a high rank prediction value.

### BRIEF DESCRIPTION OF THE DRAWINGS

FIG. 1 is a conceptual diagram of a typical recommendation system.

FIG. 2 is a diagram describing division of data for model construction.

FIG. 3 is an image diagram of calibration.

FIG. 4 is a configuration diagram of the typical recommendation system.

FIG. 5 is a configuration diagram of the recommendation system that performs typical calibration.

FIG. 6 is a diagram illustrating a relationship between a prediction value and a true value.

FIG. 7 is a configuration diagram of a recommendation system according to the present disclosure.

FIG. 8 is a diagram describing data used in the recommendation system.

FIG. 9 is a diagram illustrating calibration data and extracted calibration data.

FIG. 10 is a block diagram illustrating an example of a hardware configuration of an information processing apparatus according to an embodiment.

FIG. 11 is a functional block diagram illustrating a functional configuration of the information processing apparatus at a time of model training.

FIG. 12 is a functional block diagram illustrating a functional configuration of the information processing apparatus at a time of item recommendation.

FIG. 13 is a flowchart illustrating a process of a recommendation method performed by the information processing apparatus.

### DESCRIPTION OF THE PREFERRED EMBODIMENTS

Hereinafter, preferred embodiments of the present invention will be described with reference to the accompanying drawings. The same components are denoted by the same reference numerals, and overlapping description will not be repeated.

### Recommendation of Item Based on Prediction

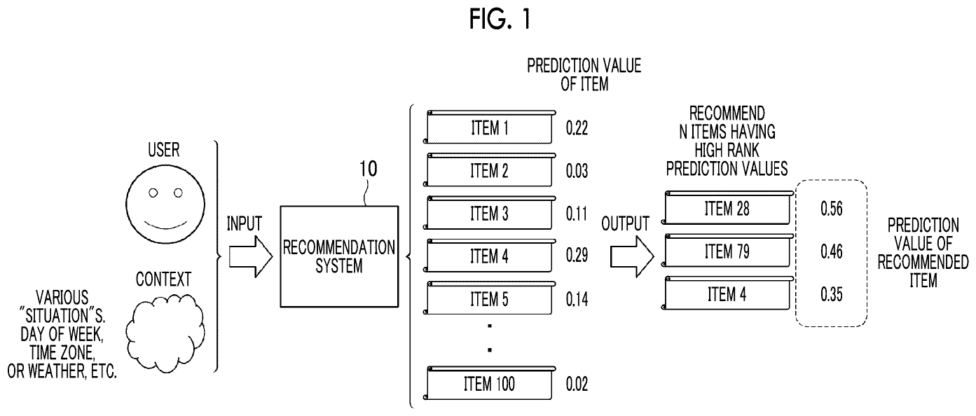

FIG. 1 is a conceptual diagram of a typical recommendation system 10. The recommendation system 10 receives information on a user and information on a context as inputs, predicts an evaluation value of an item for each user according to the context, and outputs the items of which the prediction values are top N in a case where N is an integer, to recommend the item to the user. The context means various “situation” s, and may be, for example, a day of the week, a time zone, the weather, or the like. The item may be various targets such as a product, a video, or a store. The evaluation value may be, for example, a probability of a purchase, a viewing, or a visit, a rating evaluation value after the purchase, the viewing, or the visit, and the like.

In the example illustrated in FIG. 1, the recommendation system 10 acquires a prediction value for each of items 1 to 100 which are 100 items, and recommends the items 28, 79, and 4 which are top 3 items of the prediction values. The prediction values of the item 28, the item 79, and the item 4 are 0.56, 0.46, and 0.35, respectively.

FIG. 1 illustrates an example in which a value of a prediction value is relatively large as an item of which evaluation by the user is relatively high. Therefore, the higher the value of the prediction value, the higher the rank of the prediction value. On the other hand, depending on definition of the prediction value, the value of the prediction value may be relatively small for an item for which the evaluation by the user is relatively high. In this case, the smaller the value of the prediction value, the higher the rank of the prediction value.

In a case where the user has a positive reaction to an item recommended by the recommendation system 10, it is generally considered that the recommendation is successful. The positive reaction is, for example, a purchase, a viewing, a visit, or the like. Such a recommendation technology is widely used, for example, in an electronic commerce (EC) site, a gourmet site that introduces restaurants, and the like.

### Importance of Prediction Value

A prediction value of an item is primarily used for selecting a recommendation item, but a prediction value of the selected recommendation item can be further used, and thus accuracy thereof is important.

In a case of a prediction value of an item, particularly in a case of a rating evaluation value after a purchase, after a viewing, or after a visit, the prediction value of the item may be presented to the user. For example, it is presented as “This item is expected to have a satisfaction level of 4.3 in a 5-level evaluation”. Since there is a purchase cost, a time cost for viewing a video, and the like, whether or not the recommended item is expected to have a high satisfaction level is important information for the user.

In addition, the prediction value of the item may be used for a service operation, particularly in a case where the prediction value of the item is a probability of a purchase, a viewing, or a visit. As an example, it is conceivable to adjust stock preparation based on a purchase rate, to scale a server based on a viewing rate, or to adjust a shift of an employee based on a visit rate.

### Calibration of Prediction Value

The recommendation system 10 includes a prediction model that outputs a prediction value which is a value obtained by predicting an evaluation value of a user. The prediction model is constructed by using, for example, a machine learning technology. An output score, which is a prediction value of the prediction model, is converted such that a true value and an expected value coincide with each other. This is represented by the following expression.

X is a feature amount, f(X) is a prediction model, and s is an output score of the prediction model f(X).

$$s = f ( X )$$

In addition, it is assumed that a true value of an evaluation value is y and a calibration model for converting the output score s is g(s).

$$y = g ( s )$$

Assuming that an expected value is E, the expected value E is represented by the following expression.

$$E [ Y \vert g ( s ) = y ] = y$$

Y is a response variable.

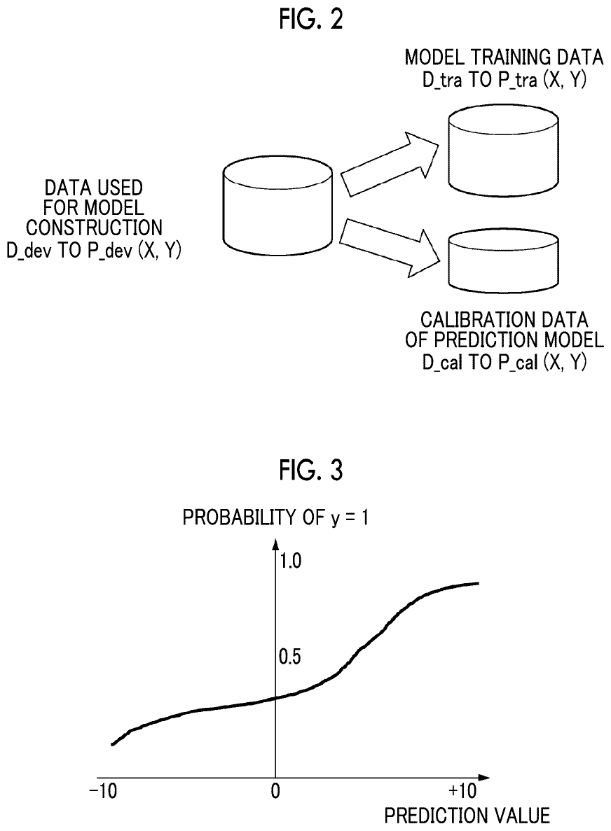

FIG. 2 is a diagram describing division of data for model construction. As illustrated in FIG. 2, data D_dev used for model construction is randomly divided into model training data D_tra and calibration data D_cal such that data distributions are the same. That is, data distributions P_dev(X, Y), P_tra(X, Y), and P_cal(X, Y) of each of the data D_dev, D_tra, and D_cal satisfy the following Expression 4.

$$P\_dev ( X , Y ) = P\_tra ( X , Y ) = P\_cal ( X , Y ) \qquad ( Expression 4 )$$

An output score of a prediction model is converted by performing the calibration using the calibration data D_cal acquired in this manner.

### Image of Calibration

FIG. 3 is an image diagram of calibration. In FIG. 3, a horizontal axis is a prediction value, and a vertical axis is a probability that a true value is 1, that is, a frequency that y=1 in the calibration data D_cal. Here, it is assumed that the prediction value and the probability of y=1 have the following relationship.
Prediction value is −10→probability of y=1 is 0.2
Prediction value is 0→probability of y=1 is 0.4
Prediction value is +10→probability of y=1 is 0.9

In this case, the prediction value 10 is converted to 0.2, the prediction value 0 is converted to 0.4, and the prediction value+10 is converted to 0.9, by the calibration.

### Representative Calibration Method

Examples of a representative calibration method include Platt scaling and isotonic regression. The Platt scaling is a method of performing logistic regression with a model prediction value as a feature amount x and a true value as a response variable y. The isotonic regression is a method of performing calibration using a step function.

### Configuration of Typical Recommendation System

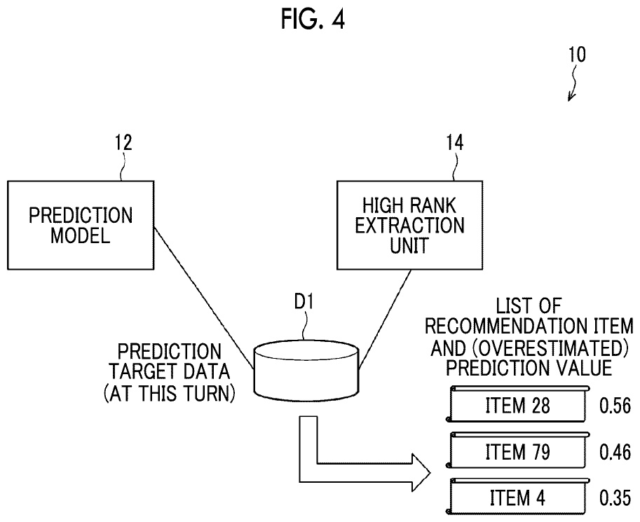

FIG. 4 is a configuration diagram of the typical recommendation system 10. The recommendation system 10 comprises prediction target data D1, a prediction model 12, and a high rank extraction unit 14.

The prediction target data D1 is data for outputting a prediction value for each item, and includes information on a user and information on a context.

The prediction model 12 acquires a prediction value for each item for a combination of the user and the context by using the prediction target data D1.

The high rank extraction unit 14 ranks the item for each user based on the prediction value for each item acquired by the prediction model 12, and extracts an item of which a prediction value has a relatively high rank for each user.

The recommendation system 10 recommends the item extracted by the high rank extraction unit 14 to the user. In the example illustrated in FIG. 4, the recommendation system 10 recommends the item 28, the item 79, and the item 4. The prediction values of the item 28, the item 79, and the item 4 are 0.56, 0.46, and 0.35, respectively, which are overestimated.

### Configuration of Typical Calibration

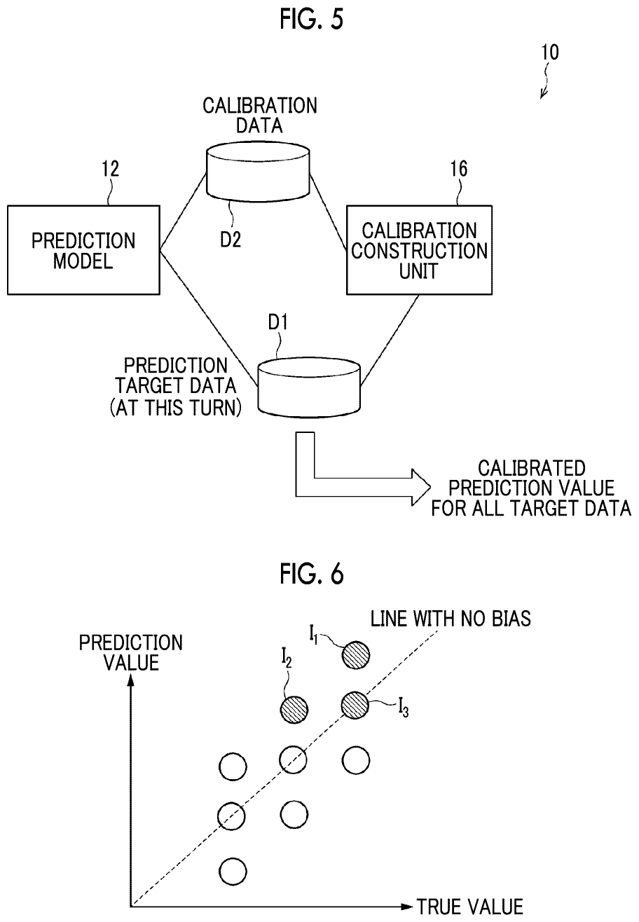

FIG. 5 is a configuration diagram of the recommendation system 10 that performs typical calibration. The recommendation system 10 comprises the prediction target data D1, calibration data D2, the prediction model 12, and a calibration construction unit 16.

The calibration data D2 is a behavior history dataset in which a past behavior of a user for an item is indicated, for each combination of a plurality of users and a plurality of items.

The calibration construction unit 16 constructs a calibration model (not illustrated) that corrects a prediction value for each item predicted by the prediction model 12 by using the calibration data D2.

The recommendation system 10 calibrates the prediction value of the prediction model 12 by using the calibration model, and acquires the calibrated prediction value for all target data.

### Problem: Overestimation Bias of Recommendation Item

FIG. 6 is a diagram illustrating a relationship between a prediction value and a true value in the recommendation system 10. In FIG. 6, a vertical axis is the prediction value, and a horizontal axis is the true value. In FIG. 6, a plurality of items are plotted. In addition, a broken line in FIG. 6 is a line indicating a position plotted in a case where there is no bias. In the example illustrated in FIG. 6, among items I1, I2, and I3 which are top three items, prediction values of two items I1 and I2 are values higher than the true values. That is, the items I1 and I2 are overestimated.

In this manner, there is a problem in that even in a case where the prediction for the entire item is calibrated, an overestimation bias for an item with a high rank prediction value remains.

In addition, in practice, due to various differences in characteristics between all the items and the high rank items, not only the overestimation bias but also an underestimation bias occur.

### Configuration of Recommendation System of Present Disclosure

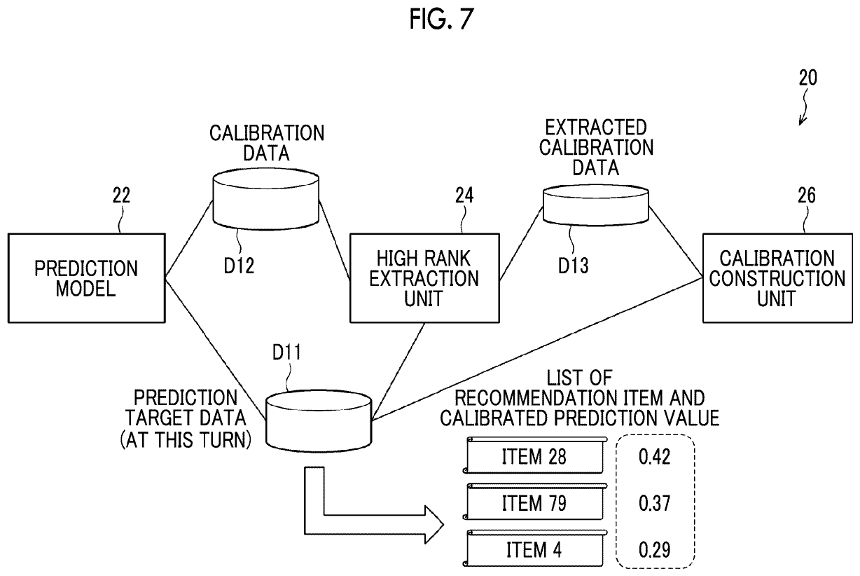

FIG. 7 is a configuration diagram of a recommendation system 20 according to the present disclosure. The recommendation system 20 is a system that recommends an item (an example of a “recommendation item”) selected from a plurality of items (an example of a “candidate item”) to a user. The recommendation system 20 comprises prediction target data D11, calibration data D12, extracted calibration data D13, a prediction model 22, a high rank extraction unit 24, and a calibration construction unit 26.

The prediction target data D11 includes information on the user and information on a context.

The prediction model 22 (an example of a “predictor”) may be a trained model that predicts an evaluation of the user for each item for a combination of the user and the context, by using the prediction target data D11, and acquires a prediction value. The prediction model 22 predicts the evaluation of the user, by using, for example, collaborative filtering.

The collaborative filtering is a method of predicting a preference of the user, by using data such as a behavior history of a large number of accumulated users. The collaborative filtering is classified into a memory-based method and a model-based method. In the memory-based method, in a case of making a recommendation, the preference of the user is predicted by directly using data such as the behavior history of the user. In the model-based method, a model representing a regularity of the preference of the user and an item is constructed in advance, and in a case of making a recommendation, a prediction is made based on the model and the preference data of the user without using data such as the behavior history.

The memory-based method is classified into a user-to-user memory-based method and an item-to-item memory-based method. In the user-to-user type, another user having a preference pattern similar to the preference pattern of the user is first found, and an item preferred by the other user is relatively highly evaluated. On the other hand, in the item-to-item type, an item similar to the item preferred by the user is relatively highly evaluated.

The memory-based collaborative filtering does not have a “trained model” in a narrow sense, but in a broad sense, in a case where the entire data (and a prediction method based on the data) used for prediction is regarded as a model, a prediction can be made by the same process as the “trained model”.

The calibration data D12 is a behavior history dataset in which a past behavior of a user for an item is indicated, for each combination of a plurality of users and a plurality of items.

The high rank extraction unit 24 extracts an item having a high rank in a prediction value, based on the prediction value for each item acquired by the prediction model 22 using the prediction target data D11. The extracted high rank item is a recommendation item recommended to the user by the recommendation system 20.

In addition, the high rank extraction unit 24 extracts data of the item having the high rank of the prediction value from the calibration data D12, based on the prediction value acquired by the prediction model 22, and sets the extracted calibration data D13. That is, the extracted calibration data D13 is a dataset of an item having a high rank in a prediction value, in the datasets of the calibration data D12.

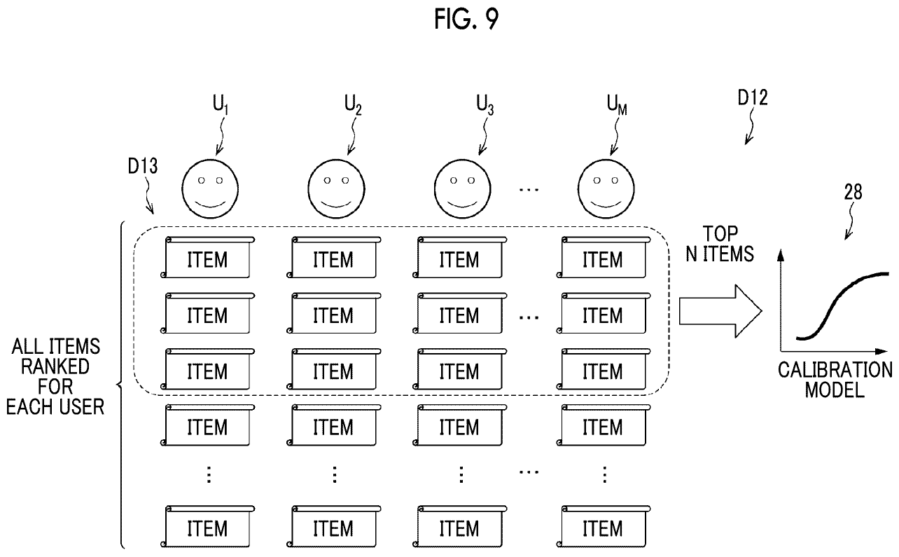

The calibration construction unit 26 constructs a calibration model 28 (an example of a “corrector”, see FIG. 9) that corrects a prediction value for each item predicted by the prediction model 22 by using the extracted calibration data D13. The calibration model 28 may include a parametric machine learning model (parametric model) in which a prediction value is an explanatory variable and a true value is a response variable, or a nonparametric machine learning model (nonparametric model). In this case, the construction of the calibration model 28 means training of the calibration model 28.

The recommendation system 20 calibrates and corrects the prediction value of the prediction model 12 by using the calibration model, and acquires the corrected prediction value for a recommendation item.

The recommendation system 20 presents the recommendation item and the corrected prediction value of the recommendation item to the user. In the example illustrated in FIG. 7, the recommendation system 20 recommends the item 28, the item 79, and the item 4. The corrected prediction values of the item 28, the item 79, and the item 4 are 0.42, 0.37, and 0.29, respectively.

### Calibration for High Rank Prediction Value

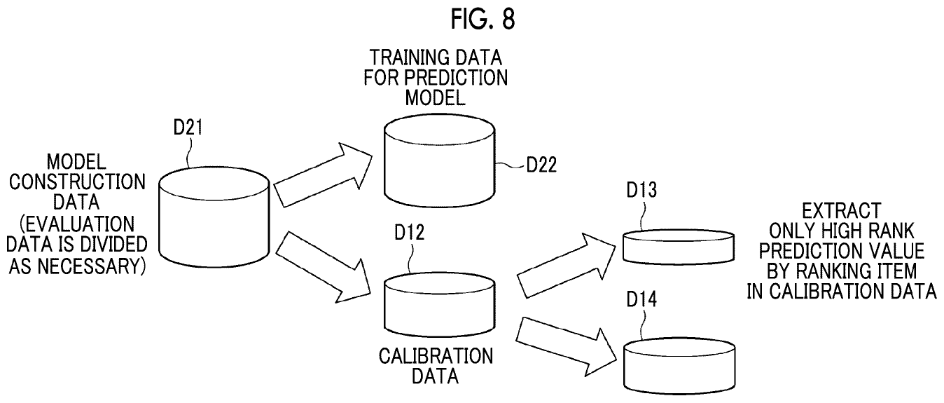

FIG. 8 is a diagram describing data used in the recommendation system 20. Model construction data D21 is used in the recommendation system 20. The model construction data D21 is a behavior history dataset in which a past behavior of a user for an item is indicated for each combination of a plurality of users and a plurality of items (an example of a “candidate item”). Model evaluation data may be divided from the model construction data D21 in advance as necessary.

The model construction data D21 is randomly divided into training data D22 of the prediction model 22 and the calibration data D12. The prediction model 22 is trained with the training data D22. That is, the recommendation system 20 inputs a combination of a user and a context of the training data D22 to the prediction model 22, and trains the prediction model 22 such that a prediction error is small. For example, the recommendation system 20 trains the prediction model 22 by using an item purchased by the user as a positive example and an item which is not purchased as a negative example. The machine learning is performed until the prediction error converges, and target prediction performance is acquired.

The calibration data D12 is verification data for verifying a relationship between a prediction value output from the prediction model 22 and a true value of the evaluation of the item by the user. The calibration data D12 is divided into the extracted calibration data D13 and other data D14. An item is ranked with a prediction value in the calibration data D12, and data of the item having a high rank is extracted, and the extracted calibration data D13 is obtained. The extracted calibration data D13 may include the prediction value of the item.

FIG. 9 is a diagram illustrating the calibration data D12 and the extracted calibration data D13. As illustrated in FIG. 9, in the calibration data D12, in a case where M is an integer, all items are ranked in an order of prediction values for each of M users U1 to UM. The extracted calibration data D13 is data in which a behavior history of the top N (the top 3 in the example illustrated in FIG. 9) items of each of the users U1 to UM is extracted. The extracted calibration data D13 is used for training the calibration model 28.

The higher the rank of the prediction value of the item, the larger the overestimation bias. Therefore, the calibration construction unit 26 may train the calibration model 28 that performs calibration for each rank, such as calibration of a first rank and calibration of a second rank. As a result, the calibration model 28 corrects the prediction value according to the rank of the prediction value of the item.

In addition, the calibration construction unit 26 may train the calibration model 28 that collectively performs calibration in a range of a certain rank, such as calibration of the ranks 1 and 2 and the calibration of the ranks 3 and 4.

In order to perform the calibration for each rank, more data for calibration is required. In this case, the calibration construction unit 26 trains the calibration model 28 by using both the prediction value and the rank of the prediction model 22 as a feature amount (explanatory variable).

Since an item with a higher rank is more likely to be viewed to a user, calibration accuracy is more important. On the other hand, the calibration construction unit 26 may perform training by assigning a relatively higher weight as the rank is higher at the training of the calibration model 28. In a case where the rank is r, the calibration construction unit 26 may perform training by weighting 1/log 2(1+r) or 1/r.

For example, in a case of Platt scaling, logistic regression is performed, and a learning sample may be weighted as in LogisticRegression( ) fit(X, y, sample_weight). As a result, a loss function in the case of training the calibration model 28 is higher as the rank is higher, and the calibration model 28 with higher accuracy for a prediction value with a higher rank can be trained.

### Outline of Information Processing Apparatus

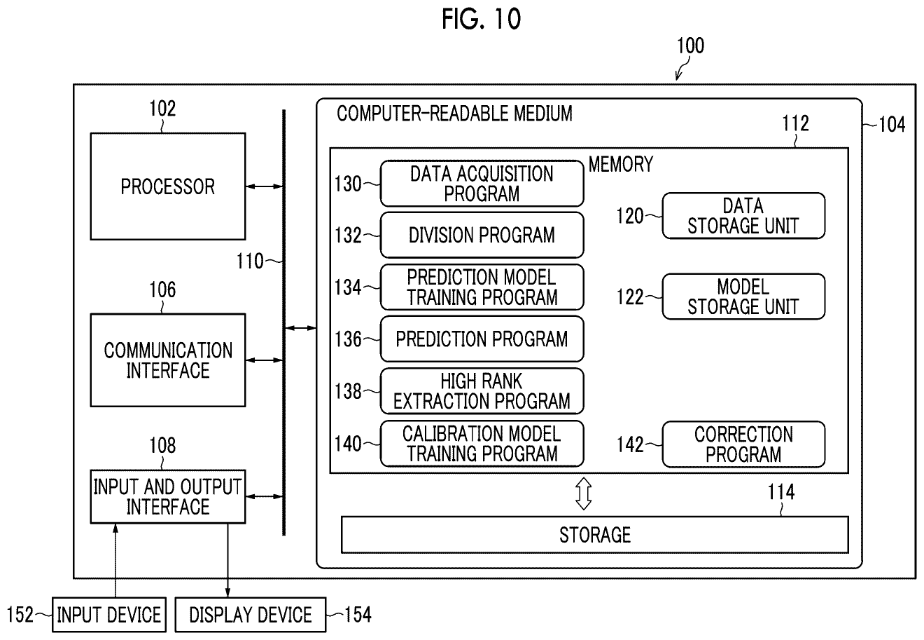

FIG. 10 is a block diagram illustrating an example of a hardware configuration of an information processing apparatus 100 that realizes the recommendation system 20. The information processing apparatus 100 comprises a function of a predictor that predicts an evaluation of a user for a candidate item, a function of acquiring verification data for verifying a relationship between a prediction value output from the predictor and a true value of the evaluation of the user for the candidate item, a function of inputting the verification data to the predictor and acquiring a high rank item that is a candidate item of which a rank of the output prediction value is relatively high, a function of extracting high rank data corresponding to the high rank item from the verification data, and a function of training a corrector that corrects an input prediction value such that the input prediction value is close to the true value based on the high rank data.

The information processing apparatus 100 further comprises a function of predicting the evaluation of the user for each candidate item of a plurality of candidate items by using the predictor, a function of selecting a candidate item having a relatively high rank of the prediction value from the plurality of candidate items as a recommendation item to be recommended to the user, a function of correcting the prediction value of the recommendation item by using the corrector, and a function of outputting the recommendation item and the corrected prediction value.

The information processing apparatus 100 can be realized by using hardware and software of a computer. The physical form of the information processing apparatus 100 is not particularly limited, and may be a server computer, a workstation, a personal computer, a tablet terminal, or the like. Although an example of realizing a processing function of the information processing apparatus 100 using one computer will be described here, the processing function of the information processing apparatus 100 may be realized by a computer system configured by using a plurality of computers.

The information processing apparatus 100 includes a processor 102, a computer-readable medium 104 that is a non-transitory tangible object, a communication interface 106, an input and output interface 108, and a bus 110.

The processor 102 executes a command stored in the computer-readable medium 104. A hardware structure of the processor 102 is various processors as described below. The various processors include a central processing unit (CPU) that is a general-purpose processor operating as various functional units by executing software (a program), a graphics processing unit (GPU) that is a processor specialized in image process, a programmable logic device (PLD) such as a field programmable gate array (FPGA) that is a processor having a circuit configuration changeable after manufacture, a dedicated electric circuit such as an application specific integrated circuit (ASIC) that is a processor having a circuit configuration dedicatedly designed to execute a specific process, and the like.

One processing unit may be configured with one of the various processors or may be configured with two or more processors of the same type or different types (for example, a plurality of FPGAs, a combination of a CPU and an FPGA, or a combination of a CPU and a GPU). Further, a plurality of functional units may be configured of one processor. As an example in which the plurality of functional units are configured of one processor, first, as typified by a computer such as a client or a server, one processor is configured of a combination of one or more CPUs and software and this processor acts as the plurality of functional units. Second, as typified by a system on chip (SoC) or the like, a processor that realizes the functions of the entire system including the plurality of functional units with one integrated circuit (IC) chip is used. In this manner, various functional units are configured by using one or more of the various processors as a hardware structure.

In addition, specifically, an electric circuit (circuitry) obtained by combining circuit elements, such as semiconductor elements, can be used as the hardware structure of the various processors.

The processor 102 is connected to the computer-readable medium 104, the communication interface 106, and the input and output interface 108 through the bus 110. The processor 102 reads out various programs, data, and the like stored in the computer-readable medium 104 and executes various processes. The term program includes the concept of a program module and includes a command conforming to the program.

The computer-readable medium 104 is a storage apparatus including a memory 112 which is a main memory and a storage 114 which is an auxiliary memory. The storage 114 is configured by using, for example, a hard disk drive (HDD) apparatus, a solid state drive (SSD) apparatus, an optical disk, a magneto-optic disk, or a semiconductor memory, or an appropriate combination thereof. Various programs, data, and the like are stored in the storage 114.

The memory 112 is used as a work region of the processor 102 and is used as a storage unit that temporarily stores the program and various types of data read from the storage 114. By loading the program that is stored in the storage 114 into the memory 112 and executing commands of the program by the processor 102, the processor 102 functions as a unit for performing various processes defined by the program. The memory 112 may be configured with one memory, or may be configured with two or more memories of the same type or different types.

The memory 112 includes a data storage unit 120 and a model storage unit 122. The data storage unit 120 is a storage region in which the prediction target data D11 and data used for model construction are stored. The model storage unit 122 is a storage region in which the prediction model 22 and the calibration model 28 are stored.

The memory 112 stores a data acquisition program 130, a division program 132, a prediction model training program 134, a prediction program 136, a high rank extraction program 138, a calibration model training program 140, various programs, various types of data, and the like executed by the processor 102.

The data acquisition program 130 is a program that executes a process of acquiring data stored in the data storage unit 120. The data acquisition program 130 may execute a process of acquiring data from the input device 152.

The division program 132 is a program that executes a process of dividing the data acquired by the data acquisition program 130. The division program 132 divides, for example, the model construction data D21 into the training data D22 of the prediction model 22 and the calibration data D12.

The prediction model training program 134 is a program that executes a process of training the prediction model 22 that predicts a behavior of a user for an item.

The prediction program 136 is a program that causes the prediction model 22 to execute a process of predicting a behavior of the user for the item.

The high rank extraction program 138 is a program that executes a process of extracting, based on a prediction value acquired by the prediction model 22, an item having a high rank of the prediction value. In addition, the high rank extraction program 138 is a program that executes a process of extracting a dataset of the item having the high rank of the prediction value from the calibration data D12 based on the prediction value acquired by the prediction model 22 and setting the extracted calibration data D13.

The calibration model training program 140 is a program that executes a process of training the calibration model 28.

The correction program 142 is a program that causes the calibration model 28 to execute a process of calibrating and correcting the prediction value acquired by the prediction program 136.

The communication interface 106 performs a wired or wireless communication process with an external device to exchange information with the external device. The information processing apparatus 100 is connected to a communication line (not illustrated) via the communication interface 106. The communication line may be a local area network, a wide area network, or a combination thereof. The communication interface 106 can play a role of a data acquisition unit that receives an input of various data such as an original dataset.

The information processing apparatus 100 may comprise an input device 152 and a display device 154. The input device 152 and the display device 154 are connected to the bus 110 via the input and output interface 108. The input device 152 may be, for example, a keyboard, a mouse, a multi-touch panel, other pointing devices, a voice input device, or an appropriate combination thereof. The display device 154 may be, for example, a liquid crystal display, an organic electro-luminescence (OEL) display, a projector, or an appropriate combination thereof. The input device 152 and the display device 154 may be integrally configured as a touch panel, or the information processing apparatus 100, the input device 152, and the display device 154 may be integrally configured as a touch panel type tablet terminal.

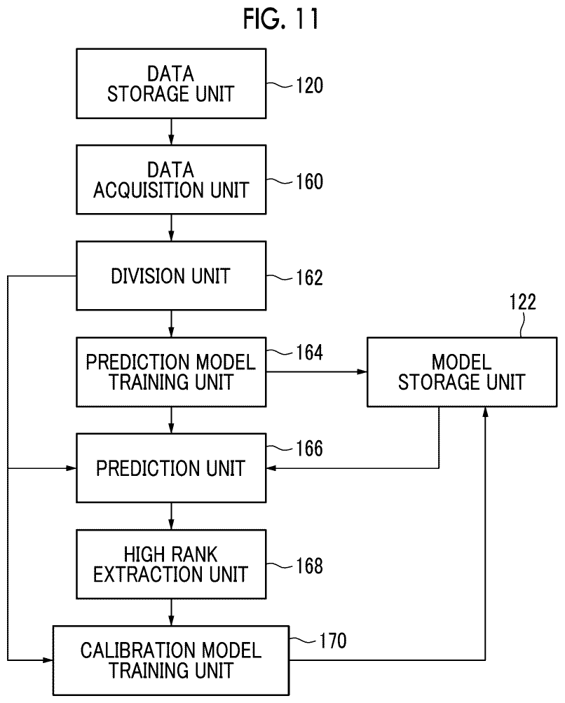

FIG. 11 is a functional block diagram illustrating a functional configuration of the information processing apparatus 100 at a time of model training. Each function illustrated in FIG. 11 is realized by the processor 102 executing each program. The information processing apparatus 100 includes a data acquisition unit 160, a division unit 162, a prediction model training unit 164, a prediction unit 166, a high rank extraction unit 168, and a calibration model training unit 170.

The data acquisition unit 160 acquires data from the data storage unit 120. The data acquisition unit 160 acquires, for example, the model construction data D21 from the data storage unit 120.

The division unit 162 divides the model construction data D21 (an example of a “plurality of pieces of data”) acquired by the data acquisition unit 160 to use a part of the data as the training data D22 of the prediction model 22 and to use the remaining part of the data as the calibration data D12.

The prediction model training unit 164 trains the prediction model 22. The prediction model 22 is stored in the model storage unit 122.

The prediction unit 166 performs a prediction on the calibration data D12 by using the prediction model 22.

The high rank extraction unit 168 includes the high rank extraction unit 24. The high rank extraction unit 168 extracts a dataset (an example of “high rank data”) of an item (an example of a “high rank item”) having a relatively high rank of a prediction value from the calibration data D12, based on the prediction value acquired by the prediction model 22, and sets the extracted calibration data D13.

The calibration model training unit 170 includes the calibration construction unit 26. The calibration model training unit 170 trains the calibration model 28 by using the extracted calibration data D13.

In this manner, the information processing apparatus 100 functions as a “learning apparatus” of the calibration model 28.

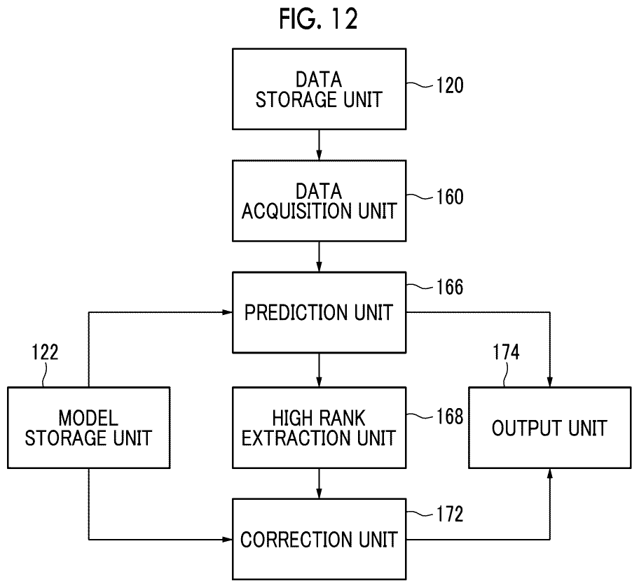

FIG. 12 is a functional block diagram illustrating a functional configuration of the information processing apparatus 100 at a time of inference, that is, at a time of item recommendation. The information processing apparatus 100 includes the data acquisition unit 160, the prediction unit 166, the high rank extraction unit 168, a correction unit 172, and an output unit 174.

The data acquisition unit 160 acquires the prediction target data D11 from the data storage unit 120.

The prediction unit 166 performs a behavior prediction of a user for an item by using the prediction model 22.

The high rank extraction unit 168 extracts an item having a high rank of a prediction value based on the prediction value acquired by the prediction unit 166.

The correction unit 172 corrects the prediction value acquired by the prediction unit 166 by causing the calibration model 28 to calibrate the prediction value.

The output unit 174 outputs the item having the high rank of the prediction value and a corrected prediction value of the item. The output unit 174 may output these to the display device 154.

In this manner, the information processing apparatus 100 functions as an “item recommendation apparatus” for the user.

### Recommendation Method

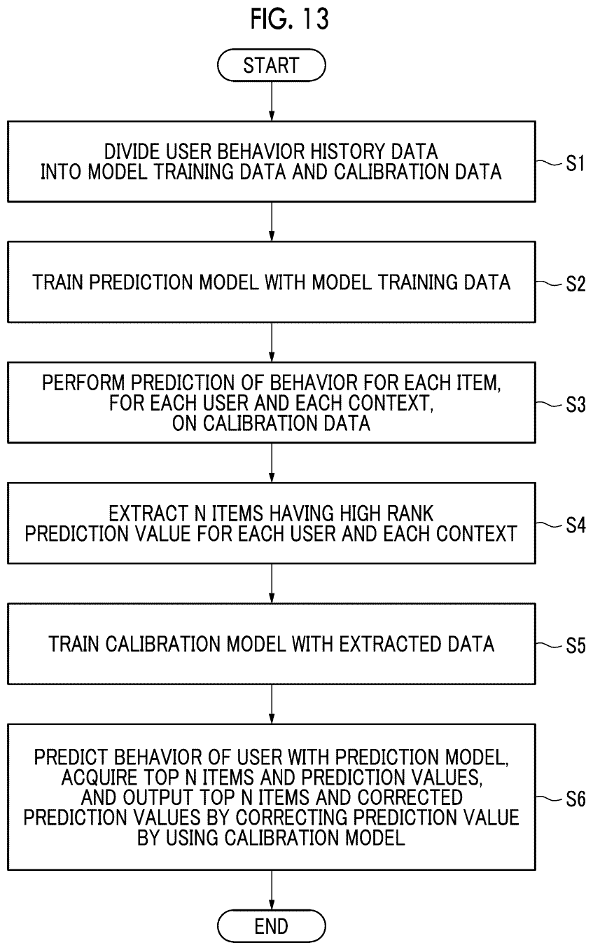

FIG. 13 is a flowchart illustrating a process of a recommendation method (an example of an “information processing method”) executed by the information processing apparatus 100. The recommendation method is realized by the processor 102 executing a recommendation program (an example of an “information processing program”) stored in the computer-readable medium 104. The recommendation program may be provided by a computer-readable non-transitory storage medium. In this case, the information processing apparatus 100 may read the recommendation program from the non-transitory storage medium, and store the recommendation program in the computer-readable medium 104.

In step S1, the data acquisition unit 160 acquires the model construction data D21 as user behavior history data, from the data storage unit 120. The division unit 162 divides the model construction data D21 into the training data D22 of the prediction model 22 and the calibration data D12.

In step S2, the prediction model training unit 164 trains the prediction model 22 by using the training data D22 which is a part of the model construction data D21.

In step S3, the prediction unit 166 performs a prediction of a behavior for each item, for each user and each context, on the calibration data D12, which is a remaining part of the model construction data D21, by using the prediction model 22, and outputs the prediction value.

In step S4, the high rank extraction unit 24 extracts data of N items having high rank prediction values for each user and each context from the calibration data D12, based on the prediction value acquired by the prediction model 22, and the extracted calibration data D13 is obtained. The extracted calibration data D13 is the number of users x the number of contexts x N pieces of data.

In step S5, the calibration model training unit 170 trains the calibration model 28 with the extracted calibration data D13 extracted in step S4. The calibration model 28 is a trained model that converts an input of a prediction value into a behavior probability, and outputs the behavior probability in a case where the prediction value is input.

In step S6, the prediction unit 166 predicts a behavior of the user with the prediction model 22 trained in step S2. The high rank extraction unit 168 ranks the items based on the prediction value, and acquires items having the top N ranks of prediction values, and the prediction values thereof. The correction unit 172 calibrates and corrects the prediction value, by using the calibration model 28 trained in step S5. The output unit 174 outputs the top N items and the corrected prediction values thereof.

Here, the number of high rank items extracted by the high rank extraction unit 24 in step S4 and the number of high rank items extracted by the high rank extraction unit 24 in step S6 are both N, which is the same number, and may be different numbers.

In the recommendation method, steps S1 to S5 correspond to a “learning method” of the calibration model 28.

### Embodiment 1

A product recommendation based on a purchase prediction of a convenience store using the recommendation system 20 will be described.

At a convenience store, there is a demand for daily push distribution of 5 recommended products to a member of an application (hereinafter, simply referred to as a “member”). The push distribution refers to transmission of information from a system side to the application of the member. Further, there is a demand for accurately grasping a purchase rate of the recommended product that is push-distributed. An operation side of the convenience store can utilize the grasping of the purchase rate for the product stock plan, adjust the coupon discount amount according to the purchase rate, and the like.

Premise conditions of Embodiment 1 are as follows. The number of members is 1 million, and the number of products for each store is approximately 1,000. Most members always use the same store. Each member purchases an average of 2 products per day, and there is a purchase history of each member for 60 days. A product lineup and a price of each product are known. The discount amount of product is changed daily.

(1) The data acquisition unit 160 acquires a purchase history stored in the data storage unit 120. The division unit 162 divides the purchase history acquired by the data acquisition unit 160 into a model training part and a calibration part. Here, the division unit 162 divides members such that 10% (100,000 people) of the purchase history is to be used for calibration and the remaining 90% (900,000 people) of the purchase history is to be used for model training among the members. The division unit 162 may divide the purchase history based on a period, such that the purchase history of the last 7 days is used for calibration and the purchase history of the remaining 53 days is used for learning.

(2) The prediction model training unit 164 trains a purchase prediction model by using the purchase history for model training. Here, the prediction model training unit 164 performs training such that the product which is purchased on each day is a positive example (1) and the product which is not purchased is a negative example (0). Meanwhile, 10 products are selected by random sampling for the negative examples. The number of pieces of learning data is 900,000×(2 positive examples+10 negative examples)×53 days=approximately 570 million pieces. Since the purchased products for the last 7 days are used as the feature amount, the number of days is 60 days−7 days=53 days.

The feature amount of purchase prediction model may be at least one of a member attribute (gender, age group, and occupation), an item attribute of each product of a recommendation candidate (product category, list price, and discount rate of each day), an item attribute of a product purchased by a member in the past one week (product category, list price, and discount rate of each day), or context information of each day (day of week, weather, maximum temperature, and minimum temperature).

The prediction model training unit 164 trains a factorization machine (FM) that vectorizes each feature amount, and represents an interaction between the feature amounts by an inner product, as a purchase prediction model. The purchase prediction model may be a prediction model other than FM, or may be a deep learning version of FM.

(3) The prediction unit 166 performs a prediction of each member, each day, and each product on the calibration data, with the purchase prediction model trained by the prediction model training unit 164. The number of prediction values predicted by the prediction unit 166 is 100,000 persons×53 days×1,000 products=5.3 billion.

(4) The high rank extraction unit 168 extracts top 5 products and prediction values thereof, for each member and each day. The number of pieces of data of the products extracted by the high rank extraction unit 168 is 100,000 persons×53 days× top 5=26,500,000 pieces.

(5) The calibration model training unit 170 performs logistic regression on the data extracted by the high rank extraction unit 168, by using the prediction value as an explanatory variable and the presence or absence of purchase as a response variable. The calibration model training unit 170 may use Platt scaling, or may use another method.

(6) The prediction unit 166 predicts a purchase of each product of each member of the day, with the purchase prediction model trained in (2) for the push distribution of the day. In addition, the correction unit 172 converts the prediction values of the top 5 products with a logistic regression model trained by (5). The output unit 174 outputs the top 5 products and a purchase prediction probability which is the prediction value after conversion. The information processing apparatus 100 transmits the top 5 products and the purchase prediction probability of each member to a terminal device on which the application of the member is installed, via the communication interface 106. The terminal device may be, for example, a smartphone, a tablet terminal, or a personal computer.

The recommendation system 20 is not limited to recommending a product having a relatively high rank of a prediction value, and may list a plurality of products including a product having a relatively low rank of the prediction value, and present the plurality of products to the user together with the purchase prediction probability. In a case where the number of products is relatively large, the recommendation system 20 may display the plurality of products to be scrolled on the terminal device.

In addition, the recommendation system 20 may not recommend the product to the user. For example, the recommendation system 20 may automatically determine the number of products to be purchased based on the purchase prediction probability without presenting the product and the purchase prediction probability to the user.

### Supplementary Note on Platt Scaling

(1) The information processing apparatus 100 typically applies a prediction model (s=f(x)) to calibration data, and prepares a dataset [(s_i, y_i)|i=1, 2, . . . , N] consisting of a pair (s_i, y_i) of a prediction value s and a true value y, to calibration data in which a high rank item is extracted from the calibration data in the present disclosure. f( ) is an optional function, and x is a feature amount used for prediction. Since x is generally multidimensional, it is assumed to be a vector.

(2) The information processing apparatus 100 acquires a calibration model g( ) by training logistic regression with s as an explanatory variable and y as a response variable.

$$g ( s ) = σ ( bs + c ) = 1 / ( 1 + exp ( - ( bs + c ) ) )$$

In addition, σ( ) represents a sigmoid function.

(3) The information processing apparatus 100 corrects the prediction value s by using the obtained calibration model g( ) to acquire a corrected prediction value yd. yd=g(s)

### Embodiment 2

A video recommendation based on a prediction for an evaluation value of a video viewing service using the recommendation system 20 will be described.

In the video viewing service, there is a request to present a recommended video list to a user. Further, there is a request to present an expected satisfaction level (for example, a rating of 1 to 5) in addition to a video name in the video list.

Premise conditions of Embodiment 2 are as follows. The number of users of the video viewing service is 10 million, and the number of videos is 1,000. There is an evaluation history (past evaluation value) of an average of 50 videos for each user.

(1) The data acquisition unit 160 acquires an evaluation history stored in the data storage unit 120. The division unit 162 divides the evaluation history acquired by the data acquisition unit 160 into a model training part and a calibration part. For example, the division unit 162 divides the evaluation history such that 20% (10 pieces on average for each user) is to be used for calibration and the remaining 80% (40 pieces on average for each user) is to be used for model training, for the evaluation history.

(2) The prediction model training unit 164 trains an evaluation prediction model by using the evaluation history for model training. Here, the prediction model training unit 164 uses collaborative filtering of an item-to-item memory-based method, and may use another prediction model. The prediction model training unit 164 calculates a similarity between the videos to use the collaborative filtering of the item-to-item memory-based method. For example, the prediction model training unit 164 may extract an evaluation value of a user who evaluates two videos, and calculate a cosine similarity.

(3) The prediction unit 166 performs a prediction of each user and each video on the calibration data, by using the evaluation prediction model trained by the prediction model training unit 164. For example, the prediction unit 166 performs a prediction by weighted averaging based on a similarity between the recommended candidate video and the past evaluation video of the user. The number of prediction values predicted by the prediction unit 166 is 10 million persons×960 videos=9.6 billion. The number of videos here is 1000-40=960 since the 40 evaluated videos used for training are excluded.

(4) The high rank extraction unit 168 extracts top 5 videos and prediction values thereof for each user. The number of pieces of data of the video extracted by the high rank extraction unit 168 is 10 million persons x top 5=50 million pieces.

(5) The calibration model training unit 170 performs binning on the prediction values of 1 to 5 into 40 pieces in increments of 0.1 ([1−1.1], [1.1−1.2], . . . ), and calculates an average of the evaluation values of the video actually evaluated in the calibration data for each bin, for the data extracted by the high rank extraction unit 168. The video evaluated by each user is a part of the entire video, and the evaluation value does not necessarily exist in all of the top 5 videos. Therefore, it is preferable that the high rank extraction unit 168 further limits the video extracted in (4) to the video in which the evaluation value exists in the calibration data among 50 million videos in which the top 5 videos of each user are extracted.

The prediction value in each bin is converted into an average value of the evaluation values. This is a calibration method called histogram binning, and another method may be used.

(6) The prediction unit 166 predicts an evaluation of each video that is not viewed by each user, with the evaluation prediction model trained in (2) for the generation of the recommended video list. In addition, the correction unit 172 converts the prediction values of the top 5 videos under the transformation condition trained in (5). The output unit 174 outputs the top 5 videos and the evaluation value prediction which is the prediction value after conversion. The information processing apparatus 100 transmits the top 5 videos and the predicted evaluation value of each user to a terminal device owned by the user, via the communication interface 106.

### Supplementary Note on Histogram Binning

(1) The information processing apparatus 100 typically applies a prediction model (s=f(x)) to calibration data, and prepares a dataset [(s_i, y_i)|i=1, 2, . . . , N] consisting of a pair (s_i, y_i) of a prediction value s and a true value y, to calibration data in which a high rank item is extracted from the calibration data in the present disclosure.
f( ) is an optional function, and x is a feature amount used for prediction. Since x is generally multidimensional, it is assumed to be a vector.

(2) Next, the information processing apparatus 100 obtains a correspondence between a true value and each bin of the dataset of (1).

(a) The information processing apparatus 100 divides the dataset of (1) into bins based on a value of s. For example, the bins are divided as bins of which s is 1.0 or more and less than 1.1, bins of which s is 1.1 or more and less than 1.2, and the like.

(b) The information processing apparatus 100 obtains an average value of values of y for each bin. For example, the information processing apparatus 100 obtains the average value, such as an average of y of bins of which s is 1.0 or more and less than 1.1 is 1.34, an average of y of bins of which s is 1.1 or more and less than 1.2 is 1.68, and the like.

(c) The information processing apparatus 100 obtains the conversion rule g(s) for each bin as the calibration rule g( ) For example, the information processing apparatus 100 obtains the conversion rule g(s) such as conversion to 1.34 in a case where s is 1.0 or more and less than 1.1, conversion to 1.68 in a case where s is 1.1 or more and less than 1.2, and the like.

(3) The information processing apparatus 100 corrects the prediction value s by using the obtained calibration model g( ) to acquire a corrected prediction value yd.

$$y d = g ( s )$$

For example, in a case where s=1.14, s is 1.1 or more and less than 1.2, and thus, conversion is performed as yd=1.68.

### Regarding Recommendation Target Item

The “item” of the present disclosure refers to a selection candidate for a recommendation, and may be a person instead of a product. An example of the item being a person is a recommendation of a candidate for a dating partner in a matching application.

In addition, another example in which the item is a person is a prediction (based on pickup) of a member who is likely to cancel a service in a membership service. In this case, a “user” of the recommendation system is a marketing person who sends a coupon to a target having a cancellation risk, and the “item” is a service member.

Further, still another example in which the item is a person is ranking (triage) of a patient who urgently needs treatment. In this case, a “user” of the recommendation system is a doctor and a nurse, and the “item” is a patient.

### Embodiment 3

A prediction and a recommendation of a service member having a cancellation risk by using the recommendation system 20 will be described.

In a membership service, there is a demand for specifying a member who is likely to cancel the membership service and for taking a measure for preventing the cancellation for the specified member. The measure for preventing cancellation is, for example, sending a coupon that is more profitable than other members (for example, a discount coupon with a relatively large discount amount than other members). Such a coupon is a coupon that may have a negative profit and loss, and thus there is a request to limit the delivery of the coupon to a member having a certain level or higher cancellation risk. Therefore, a prediction value of a cancellation rate is important.

Premise conditions of Embodiment 3 are as follows. The number of members of the membership service is 100,000, and there are age groups, occupations, and service use indicators of each member at the present time. The use indicator is, for example, recency frequency monetary (RFM). In addition, there is cancellation person information in the past year. The cancellation person information includes, for example, whether or not the 100,000 members who were members one year ago canceled their membership thereafter, the age group, the occupation, and the service use indicator of each member at the time point one year ago.

(1) The data acquisition unit 160 acquires cancellation person information stored in the data storage unit 120. The division unit 162 divides the cancellation person information acquired by the data acquisition unit 160 into information for model training and information for calibration. For example, the division unit 162 divides 20% (20,000 people) of the cancellation person information for calibration and divides the remaining 80% (80,000 people) for model training.

(2) The prediction model training unit 164 trains a cancellation prediction model by using the cancellation person information for model training. For example, the prediction model training unit 164 trains a gradient boosting decision tree (GBDT), by using an attribute of the member and the service use indicator as feature amounts.

(3) The prediction unit 166 predicts a cancellation rate of each member with respect to the calibration data by using the cancellation prediction model trained by the prediction model training unit 164.

(4) The high rank extraction unit 168 extracts the top 1% of members with a high predicted cancellation rate and the cancellation rate.

(5) The calibration model training unit 170 performs logistic regression on the extracted data with the cancellation rate as an explanatory variable and the presence or absence of cancellation as a response variable. The calibration model training unit 170 may use Platt scaling or may use another method.

(6) The prediction unit 166 predicts the cancellation rate of each member with the cancellation prediction model trained in (2) for the current time point for the cancellation prevention measure. In addition, the correction unit 172 performs conversion with the conversion condition trained by (5) for the cancellation rate of the top 1% of the members. The output unit 174 outputs the conversion cancellation rate of the top 1% of the members. The information processing apparatus 100 may transmit a coupon to the member whose converted cancellation rate is greater than a threshold value via the communication interface 106.

### Application to Medical Field

The recommendation method according to the present disclosure can also be applied to a medical field.

By applying Embodiment 1 to the medical field, it is possible to recommend a prescription for a patient. For example, the present invention can be applied to a recommendation system that performs ranking based on a prescription probability.

By applying Embodiment 2 to the medical field, it is possible to recommend a hospital and a doctor to a patient. For example, the present invention can be applied to a recommendation system that performs ranking based on a prediction of a rating of a review web.

By applying the Embodiment 3 to the medical field, it is possible to screen a patient in an intensive care unit (ICU). For example, the present invention can be applied to a recommendation system that predicts and recommends a patient to be admitted to the ICU among inpatients.

### Others

The present disclosure is not limited to the embodiments described above, and various modifications can be made within the scope of the technical concept of the present disclosure without departing from its gist.

### EXPLANATION OF REFERENCES

10: recommendation system
12: prediction model
14: high rank extraction unit
16: calibration construction unit
20: recommendation system
22: prediction model
24: high rank extraction unit
26: calibration construction unit
28: calibration model
100: information processing apparatus
102: processor
104: computer-readable medium
106: communication interface
108: input and output interface
110: bus
112: memory
114: storage
120: data storage unit
122: model storage unit
130: data acquisition program
132: division program
134: prediction model training program
136: prediction program
138: high rank extraction program
140: calibration model training program
142: correction program
152: input device
154: display device
160: data acquisition unit
162: division unit
164: prediction model training unit
166: prediction unit
168: high rank extraction unit
170: calibration model training unit
172: correction unit
174: output unit
D1: prediction target data
D2: calibration data
D11: prediction target data
D12: calibration data
D13: extracted calibration data
D14: data
D21: model construction data
D22: training data
I1, I2, I3: item
S1 to S6: steps of recommendation method
U1, U2, U3, UM: user

What is claimed is:

1. An information processing apparatus comprising:
one or more processors; and
one or more memories that store a command to be executed by the one or more processors,
wherein the processor is configured to:
acquire verification data for verifying a relationship between a prediction value output from a predictor that predicts an evaluation of a user for a candidate item and a true value of the evaluation of the user for the candidate item;
input the verification data to the predictor, and acquire a high rank item which is a candidate item of which a rank of the output prediction value is relatively high;
extract high rank data corresponding to the high rank item from the verification data; and
train a corrector that corrects an input prediction value such that the input prediction value is close to the true value based on the high rank data.

2. The information processing apparatus according to claim 1,
wherein the processor is configured to:
predict each evaluation of the user for each candidate item of a plurality of candidate items by using the predictor;
select a candidate item of which a rank of a prediction value is relatively higher among the plurality of candidate items, as a recommendation item to be recommended to the user;
correct the prediction value of the recommendation item by using the corrector; and
output the recommendation item and the corrected prediction value.

3. The information processing apparatus according to claim 1,
wherein the predictor predicts the evaluation of the user by using collaborative filtering.

4. The information processing apparatus according to claim 1,
wherein the predictor includes a trained model, and
the processor is configured to:
divide a plurality of pieces of data to use a part of the data for training of the predictor and to use a remaining part of the data as the verification data.

5. The information processing apparatus according to claim 1,
wherein the processor is configured to:
limit the high rank item to a candidate item for which the evaluation of the user exists in the verification data.

6. The information processing apparatus according to claim 2,
wherein the processor is configured to:
extract the number of high rank items equal to the number of recommendation items.

7. The information processing apparatus according to claim 1,
wherein the corrector includes a parametric model or a nonparametric model in which the prediction value is an explanatory variable and the true value is a response variable.

8. The information processing apparatus according to claim 1,
wherein the corrector corrects the prediction value according to the rank of the prediction value of the high rank item.

9. The information processing apparatus according to claim 7,
wherein the corrector includes the rank of the prediction value in the explanatory variable.

10. The information processing apparatus according to claim 1,
wherein the processor is configured to:
correct the prediction value by assigning a relatively higher weight to a prediction value having a relatively higher rank.

11. The information processing apparatus according to claim 10,
wherein the corrector is trained by assigning the relatively higher weight to the prediction value having a relatively higher rank.

12. An information processing method executed by one or more processors,
wherein the one or more processors are configured to:
acquire verification data for verifying a relationship between a prediction value output from a predictor that predicts an evaluation of a user for a candidate item and a true value of the evaluation of the user for the candidate item;
input the verification data to the predictor, and acquire a high rank item which is a candidate item of which a rank of the output prediction value is relatively high;
extract high rank data corresponding to the high rank item from the verification data; and
train a corrector that corrects an input prediction value such that the input prediction value is close to the true value based on the high rank data.

13. A non-transitory, computer-readable tangible recording medium which a program for causing, when read by a computer, one or more processors of the computer to execute the information processing method according to claim 12.
